(19) United States
(12) Patent Application Publication
(10) Pub. No.: US 2011/0139997 A1
(43) Pub. Date: Jun. 16, 2011

(54) Ion transporter, ion transport method, ion beam irradiator, and medical particle beam irradiator

(75) Inventors: Hironao Sakaki, Kyoto (JP); Mamiko Nishiuchi, Kyoto (JP); Toshihiko Hori, Kyoto (JP); Masayuki Suzuki, Kyoto (JP); Yasushi Iseki, Kanagawa (JP); Takeshi Yoshiyuki, Kanagawa (JP)

(73) Assignees: JAPAN ATOMIC ENERGY AGENCY, Ibaraki (JP); KABUSHIKI KAISHA TOSHIBA, Tokyo (JP)

(21) Appl. No.: 12/926,097

(22) Filed: Oct. 26, 2010

(30) Foreign Application Priority Data
Oct. 28, 2009 (JP) 2009-247729

(51) Int. Cl. H01J 1/50

(52) U.S. Cl. 250/396 ML

(57) ABSTRACT

To obtain high-directivity, stable, and high-intensity ion beam.

An ion beam irradiator 10 is constituted by a combination of a laser-driven ion/electron generator 20 and an ion transporter 30 and is configured to guide ion beam with low directivity emitted from the ion/electron generator 20 to the output end while increasing the directivity of the ion beam or focusing the ion beam at the ion transporter 30. In the ion transporter 30, an electron absorber 33 is provided around a beamline 31 at a location on the upstream side in terms of the flow of the ion beam relative to multipole magnets 32. The electron absorber 33 is formed of a material (e.g., polytetrafluoroethylene (PTFE)) that can effectively absorb high-energy electrons. The electron absorber 33 is surrounded by an X-ray shield 34 made of heavy metal such as lead.

### BACKGROUND OF THE INVENTION

1. Field of the Invention

The present invention relates to an ion transporter capable of increasing the directivity of particle beam (ion beam) for output when the particle beam is passed therethrough and an ion transport method. Further, the present invention relates to structures of an ion beam irradiator and a medical particle beam irradiator using the ion transporter and ion transport method.

2. Description of the Related Art

There are known various techniques that irradiate a sample with ion beam obtained by accelerating ion (including proton) to perform fabrication, film formation, analysis, medical practice, etc. In such techniques, it is necessary to stably generate high-energy and high-intensity ion beam (particle beam). In general, an apparatus for generation and irradiation of high-energy ion beam requires large-scale facilities especially for an acceleration mechanism, resulting in an increase in the size of the entire apparatus. Thus, even through it is clear that such an ion beam (particle beam) irradiator is effective especially for medical use, the ion beam irradiator is far from widespread.

In such a situation, there is known a laser-driven ion beam irradiator as an ion beam irradiator capable of being down-sized. In the laser-driven ion beam irradiator, as disclosed in Patent Documents 1 and 2, by irradiating a target formed of metal, polymer, etc. which can generate a large number of protons with high-intensity ultra-short pulse laser beam, the target material is evaporated and is made into plasma. In the plasma, electrons whose mass is lower are first accelerated to be high-energy state, and then protons whose mass is heavier are then accelerated by an electric field created by the electrons. The protons are then radiated in the form of high-energy proton beam onto a sample. Not only the protons but also ions can be accelerated in the same manner and can be radiated in the form of ion beam. The laser-driven ion beam irradiator can be made significantly compact as compared to a conventional large-size accelerator and thus expected for application to various fields such as medical fields.

Patent Document 1 discloses a technique that optimizes the thickness of the target and laser beam irradiation energy density so as to obtain high-efficiency/high-energy ion beam. Patent Document 2 discloses a technique that increases the energy transmission efficiency from the laser light to ions by adjusting the electron density distribution in the target so as to obtain high-energy ion beam.

However, in the abovementioned methods, the generated ion beam has low directivity and therefore the ions are radiated with a given spread angle. Thus, in order to obtain satisfactory intensity at a portion onto which the ion beam is radiated, it is necessary to increase the directivity of the ion beam or to focus the ion beam. Non-patent Document 1 discloses a technique realizing this. A configuration of an ion beam irradiator of Non-patent Document 1 is illustrated in FIG. 3. In an ion beam irradiator 90, laser light 92 emitted from a laser light source 91 enters a focusing mirror 95 through two plane mirrors 93 and 94. The focal point of the focusing mirror 95 is set on a target 96, so that the laser light has extremely high-energy density on the target 96. Ion beam (particle beam) 97 generated from the target 96 by the irradiation is radiated with a given spread angle from the irradiated portion. The ion beam irradiator 90 has a plurality of multipole magnets (magnets for focusing ions) 98 for applying a multipole (e.g., quadrupole or hexapole) magnetic field to the ion beam 97. The multipole magnets 98 is set to form a magnetic field for deflecting the ion beam 97 to be focused to a preset output target 100, using permanent magnets or electromagnets. When the affected area of a patient is set as the output target 100, high-energy/high-intensity ion beam (particle beam) 97 can be used for medical treatment. In this configuration, the plane mirror 94, focusing mirror 95, target 96, and multipole magnets 98 are provided in a vacuum chamber 99. The laser light 92 enters the vacuum chamber 99 through an optical window, and the ion beam 97 is emitted from the vacuum chamber 99 through a beamline.

In the ion beam irradiator 90, electrons are emitted from the target 96 together with the ions. In this configuration, the difference in the mass between the ion and electron is utilized to allow the magnetic filed formed by the multipole magnets 98 to optimize the trajectory of the ions in the ion beam. This allows only the ion beam 97 to be focused and electron beam to be spread out. As described above, the electrons perform important role for ion acceleration. However, from a viewpoint that the ion beam 97 is utilized at the output target 100, the electron beam at the output end is unnecessary and is preferably removed (so that the electron beam is negligible as compared to the ion beam 97). In this case, the multipole magnets 98 are used to selectively focus only the ion beam 97 to thereby achieve the removal of the electron beam. In this configuration, the portion in which the multipole magnets 98 are provided can be considered as an ion transporter. That is, the directivity of the ion beam is improved by the ion transporter when the ion beam is passed therethrough so as to obtain high-intensity at the output target 100.

Therefore, by the use of the ion beam irradiator 90 (ion transporter), high-directivity/high-intensity ion beam can be obtained.

### CITATION LIST

### Non-Patent Document

[Non-Patent Document 1] M. Nishiuchi, I. Daito, M. Ikegami, H. Daido, M. Mori, S. Orimo, K. Ogura, A. Sagisaka, A. Yogo, A. S. Pirozhkov, H. Sugiyama, H. Kiriyama, H. Okada, S. Kanazawa, S. Kondo, T. Shimomura, M. Tanoue, Y. Nakai, H. Sasao, D. Wakai, H. Sakaki, P. Bolton, I. W. Choi, J. H. Sung, J. Lee, Y. Oishi, T. Fujii, K. Nemoto, H. Souda, A. Noda, Y. Iseki, and T. Yoshiyuki, “Focusing and spectral enhancement of a repetition-rated, laser-driven, divergent multi-MeV proton beam using permanent quadpole magnets”, Applied Physics Letters Vol. 94, issue. 6, 1107, 2009

### Patent Document

[Patent Document 1] Jpn. Pat. Appln. Publication No. 2006-244863
[Patent Document 2] Jpn. Pat. Appln. Publication No. 2008-198566

However, in the ion beam irradiator 90 disclosed in Non-patent Document 1, there may be a case where the electrons indirectly influence the ion beam 97 in the multipole magnetic field. FIG. 4 illustrates a simulation result of electron distribution around the multipole magnets (three magnets) 98 in the ion beam irradiator 90 having the configuration described above. In FIG. 4, the electron density is represented by shading, darker part being high electron density and lighter part being low electron density. Three rectangles in FIG. 4 correspond to the multipole magnets 98, and the target 96 is located in the left side relative to FIG. 4. The trajectory of the ions in the ion beam 97 is deflected by the multipole magnetic field in the direction so that the ions to be focused, while the electrons are not focused but spread out, so that the left side (incident side) multipole magnet 98 is exposed to high-density electrons. Further, in this situation, not only the electrons directly emitted from the target 96 side but also secondary electrons generated when the left side (incident side) multipole magnet 98 is exposed to high-energy electrons exist.

When the permanent magnets constituting the multipole magnets 98 are exposed to such electrons, surface current flows on the surfaces of the permanent magnets, casing a magnetic filed. This magnetic field is applied to the magnetic field set so as to focus the ion beam 97, deviating the trajectory of the ions in the ion beam 97 from the set range. Such movement of the electrons is influenced by the charging of respective components and is thereby changed with time. As a result, a problem occurs in which the focusibility of the ion beam 97 is degraded, the intensity of the ion beam 97 at the output end becomes unstable, or the accuracy of ion beam measurement at the output end is degraded by a voltage change caused by generation of the surface current generated when the multipole magnet 98 is exposed to the electrons.

That is, it has been difficult to obtain an ion beam irradiator capable of stably emitting high-directivity/high-intensity ion beam.

### SUMMARY OF THE INVENTION

The present invention has been made in view of the above problem, and an object thereof is to provide an invention that solves the above problem.

To solve the above problem, the present invention is configured as follows.

According to an aspect of the present invention, there is provided an ion transporter that is connected to an ion/electron generation source for generating ion beam and electron beam and uses a magnet for focusing ions to focus the ion beam for output, comprising: a beamline provided between the ion/electron generation source and output target of the ion beam so as to allow the ion beam to pass therethrough and having the magnet for focusing ions therearound; and an electron absorber that is provided around the beamline at a location between the ion/electron generation source and magnet for focusing ions through which the electron beam passes.

In the ion transporter according to the present invention, an X-ray shield is provided around the electron absorber.

In the ion transporter according to the present invention, the portion of the beamline at which the electron absorber is provided and the ion/electron generation source are electrically isolated from each other, and the portion of the beamline at which the electron absorber is provided and portion at which the magnet for focusing ions is provided are electrically isolated from each other.

In the ion transporter according to the present invention, an electron deflection apparatus for spreading out the electron beam is provided around the beamline at a location between the electron absorber and ion/electron generator.

According to another aspect of the present invention, there is provided an ion transport method that transports ion beam traveling from an ion/electron generation source for generating ion beam and electron beam and uses a magnet for focusing ions to focus the ion beam for output, comprising: providing a beamline between the ion/electron generation source and output target of the ion beam so as to allow the ion beam to pass therethrough; providing the magnet for focusing ions at a portion around the beamline; and providing an electron absorber around the beamline at a location between the ion/electron generation source and magnet for focusing ions through which the electron beam passes.

In the ion transport method according to the present invention, an X-ray shield is provided around the electron absorber.

In the ion transport method according to the present invention, the portion of the beamline at which the electron absorber is provided and the ion/electron generation source are electrically isolated from each other, and the portion of the beamline at which the electron absorber is provided and portion at which the magnet for focusing ions is provided are electrically isolated from each other.

In the ion transport method according to the present invention, the trajectory of the electron beam is controlled at a location between the electron absorber and ion/electron generation source in the direction in which the electron beam is spread out.

In the ion transport method according to the present invention, a laser-driven ion/electron generation source in which a target is irradiated by laser light to generate ion beam and electron beam is used as the ion/electron generation source to the output ion beam.

According to a still another aspect of the present invention, there is provided an ion beam irradiator that irradiates a sample with ion beam through the ion transporter

In the ion beam irradiator according to the present invention, a laser-driven ion/electron generation source in which a target is irradiated by laser light to generate ion beam and electron beam is used as the ion/electron generation source.

According to a still another aspect of the present invention, there is provided a medical particle beam irradiator, wherein the ion beam is set as particle beam to be radiated,

a laser-driven ion/electron generation source in which a target is irradiated by laser light to generate ion beam and electron beam is used as the ion/electron generation source, and the ion beam output using the ion transporter is irradiated

With the above configuration, high-directivity and high-intensity ion beam can stably be irradiated.

### BRIEF DESCRIPTION OF THE DRAWINGS

FIG. 1 is a view illustrating a configuration of an ion beam irradiator according to an embodiment of the present invention;

FIG. 2 is an enlarged view of a configuration around an electron absorber in the ion beam irradiator according to the embodiment of the present invention;

FIG. 3 is a view illustrating an example of a configuration of a conventional ion beam irradiator; and

FIG. 4 illustrates a simulation result of electron distribution around magnets for focusing ion beam in the conventional ion beam irradiator.

### DETAILED DESCRIPTION OF THE PREFERRED EMBODIMENTS

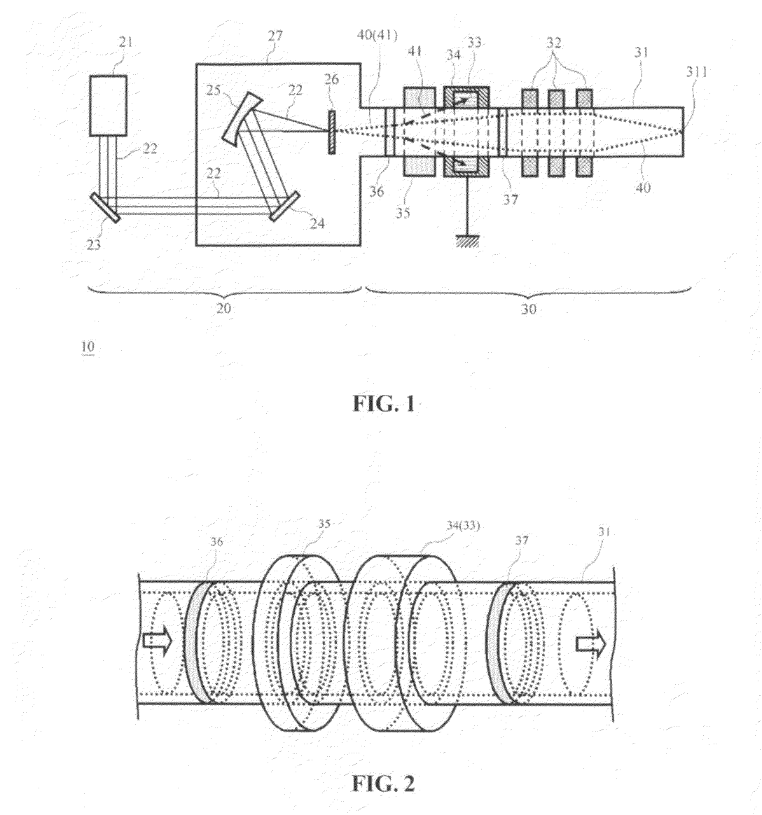

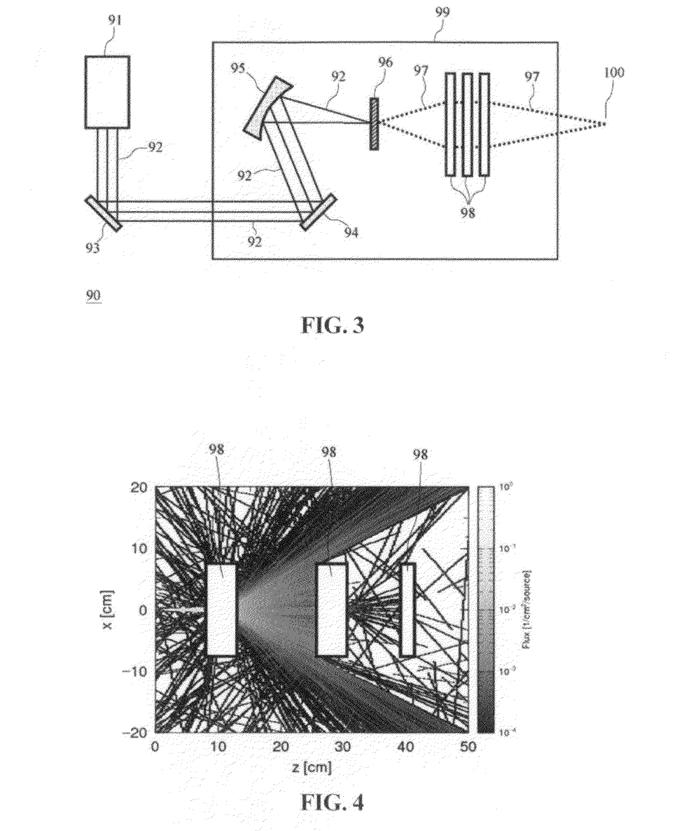

An ion beam irradiator according to an embodiment of the present invention will be described below. FIG. 1 is a view illustrating a configuration of an ion beam irradiator 10. It is assumed that the ionic species constituting ion beam (particle beam) generated by the ion beam irradiator 10 include protons. The ion beam irradiator 10 is constituted by a combination of a laser-driven ion/electron generator (ion/electron generation source) 20 and an ion transporter 30 and is configured to guide ion beam with low directivity emitted from the ion/electron generator 20 to the output end while increasing the directivity of the ion beam or focusing the ion beam at the ion transporter 30.

In the laser-driven ion beam irradiator 10 (ion/electron generator 20), high-intensity/ultra-short pulse laser light 22 emitted from a laser light source 21 enters a focusing mirror 25 through two plane mirrors 23 and 24. The focal point of the focusing mirror 25 is set on a target 26, so that the laser light has extremely high-energy density on the target 26.

The laser light source 21 may be a light source that can emit ultra-short pulse laser light having an intensity high enough to turn the target into plasma in a state where the laser light is focused to the target. This point is the same as that described in Patent Documents 1, 2 and Non-Patent Document 1. More specifically, a YAG laser may be used. In this case, the laser light 22 is generated so as to achieve an output of about 40 femtoseconds/630 millijoule on the target 26. The Rayleigh length and the like of the focusing mirror 25 are appropriately set so as to effectively generate plasma on the target 26 for acceleration of the ions and protons.

The target 26 is made of elements being as ionic species or material (e.g., metal or polymer) that generates a large number of protons. The shape of the target 26 is appropriately set so that plasma is effectively generated.

Thus, as in the case of Patent Document 1, 2, and Non-Patent Document 1, when the target 26 is irradiated with focused laser light 22, elements constituting the target 26 are evaporated and thus tuned into plasma, whereby high-energy electrons are generated. By an electric field created by the high-energy electrons, the ions are accelerated up to an energy of about 3.0 MeV. The ions and electrons are accelerated in the radiation direction of the laser light 22 (right direction in FIG. 1). However, the ions and electrons have low directivity and are thus radiated spreadly. In the configuration of FIG. 1, the plane mirror 24, focusing mirror 25, and target 26 are provided in a vacuum chamber 27. The laser light 22 enters the vacuum chamber 27 through an optical window (not illustrated).

Ion beam 40 and electron beam 41 thus generated enter the ion transporter 30 (beamline 31) with a given spread angle (for example, about 10 degrees on one side). The beamline 31 is connected to the vacuum chamber 27 so as to allow especially the ion beam 40 to pass therethrough. However, at the time when the ion beam 40 passes through the beamline 31, the electron beam 41 also passes through the beamline 31. Three multipole magnets (magnets for focusing ions) 32 for applying a multipole (e.g., quadrupole or hexapole) magnetic field to the ion beam 40 are provided around the beamline 31 made of metal (e.g., stainless). The ions in the ion beam 40 is deflected by the multipole magnetic field in the focusing direction of the ion beam 40 to allow the ion beam 40 to be focused at a preset beamline end portion 311, whereby high-intensity ion beam is obtained. That is, the multipole magnetic field can be set such that the ion beam 40 focused at the beamline end portion 311 to have high-intensity can be irradiated onto a sample placed at the beamline end portion 311. This point is the same as that described in the technique of Non-patent Document 1. Although three multipole magnets 32 in this example, the number of the multipole magnets 32 and specification of each magnet may be appropriately set in consideration of the focusibility and controllability of the ion beam 40. Inside of the beamline 31 is vacuum like the vacuum chamber 27 so as to be connected to the vacuum chamber 27. The location of the beamline end potion 311 (location at which the sample is placed) can be previously set in consideration of the apparatus configuration, and the length and the like of the beamline 31 are set depending on the location of the beamline end portion 311. The configuration illustrated in FIG. 1 is simplified for illustrative purpose and, in addition to the components illustrated in FIG. 1, a bending magnet may be provided so as to deflect the ion beam 40 and to change the traveling direction of the ion beam 40. In response to the change of the traveling direction, the location of the beamline end portion 311 at which high-intensity ion beam 40 can be obtained or the direction in which the sample is placed can be appropriately set.

In the ion transporter 30, an electron absorber 33 is provided around the beamline 31 at a location on the upstream side in terms of the flow of the ion beam (hereinafter, referred to merely as upstream side) relative to the multipole magnets 32 through which the electron beam 41 emitted from the ion/electron generator 20 passes. The electron absorber 33 is formed of a material (e.g., polytetrafluoroethylene (PTFE)) that can effectively absorb high-energy electrons. The electron absorber 33 may be covered with high-resistance film (formed by evaporation, etc.) on its surface and is grounded by a conductive wire. The electron absorber 33 is surrounded by an X-ray shield 34 made of heavy metal such as lead.

An electron deflection apparatus 35 is provided on the upstream side relative to the electron absorber 33 (X-ray shield 34). Like the multipole magnets 32 for the ion beam 40, the electron deflection apparatus 35 is formed of a magnet that generates, e.g., a multipole magnetic field and can change the trajectory of the electron beam 41 (broken arrows). The multipole magnets 32 have a function of focusing the ion beam 40; on the other hand, the electron deflection apparatus 35 has a function of spreading out the electron beam 41. Here, based on the difference in the mass between the ion and electron, the trajectory of the electron beam 41 is deflected by a weak magnetic field to allow only the electron beam 41 to be spread out without giving great influence on the trajectory of the ion beam 40. For this purpose, the electron deflection apparatus 35 is formed of the magnet for generating the multipole magnetic field; alternatively however, the electron deflection apparatus 35 may be formed of an electromagnet for generating a high-speed pulse magnetic field or may be configured to apply an electric field such as a pulse electric field to the electron beam 41.

Insulators 36 and 37 are inserted into the beamline 31 at the locations on the upstream and downstream sides relative to the electron absorber 33 (X-ray shield 34). With this configuration, the portion between the insulators 36 and 37 (the beamline 31 at this portion, X-ray shield 34, and the like) is electrically insulated from the upstream portion relative to the insulator 36 and downstream portion relative to the insulator 37.

The schematic view of the ion transporter 30 around the electron deflection apparatus 35 and electron absorber 33 is illustrated in FIG. 2. The electron absorber 33 (X-ray shield 34) and electron deflection apparatus 35 are provided so as to surround the beamline 31. The insulators 36 and 37 are provided by substituting a part of the beamline 31 made of metal.

The ion beam 40 and electron beam 41 generated from the vacuum chamber 27 (target 26) pass through the beamline 31 from the left to right in FIGS. 1 and 2. However, the ion beam 40 and electron beam 41 have low directivity immediately after being generated from the vacuum chamber 27 (target 26) and are therefore radiated spreadly.

The electron beam 41 travels along the same trajectory as that of the ion beam 40 on the upstream side relative to the electron deflection apparatus 35 and, after that, the spread angle of the electron beam 41 is increased by the electron deflection apparatus 35. At this time, as described above, the ion beam 40 is not significantly influenced. Thus, by providing the electron absorber 33 around the beamline 31 at the location between the ion/electron generator 20 and multipole magnets 32, it is possible to increase the efficiency with which the electron beam 41 is absorbed by the electron absorber 33. Although the beamline 31, X-ray shield 34, and the like are exposed to the electrons, electrical influence caused by the exposure to the electrons can be removed by providing the insulators 36 and 37, by grounding the beamline 31 at this location, and the like.

The ion beam 40 passes through the portion at which the electron absorber 33 and the like are provided and, after that, focused by the three multipole magnets 32. This allows the ion beam 40 to be focused at the end of the beamline 31 and to have high-intensity. At this time, it is possible to compensate influence on the ion beam 40 given by the electron deflection apparatus 35.

At this time, most of the electron beam 41 is absorbed by the beamline 31 at the location at which the electron absorber 33 and the like are provided, so that adverse effect that the electrons may give to the multipole magnets 32 is removed. Although X-ray is radiated from the electron absorber 33 or beamline 31 that has absorbed the electrons, the X-ray is shielded by the X-ray shield 34.

Thus, by the use of the ion beam irradiator 10 (or ion transporter 30), high-intensity ion beam can stably be irradiated onto a sample at the beamline end portion 311. In particular, it is possible to allow the ion beam 40 and electron beam 41 having low directivity generated from the ion/electron generator 20 to pass through the ion transporter 30, whereby only the ion beam 40 can be output to the beamline end portion 311 as stable and high-intensity ion beam. This effect is noticeable when the ion/electron generation source, like the laser-driven ion/electron generator 20, that generates both the ion beam and electron beam with low directivity is employed.

The influence of the multipole magnets 32 on the trajectory of the ion beam 40 in the above ion beam irradiator 10 can be calculated accurately by a numerical simulation performed at the time of, e.g., design of the ion transporter 30, thereby optimizing the ion beam 40 at the beamline end portion 311. Actually, however, the multipole magnetic field is influenced by the behavior of the electron beam, and the influence of the electrons on the multipole magnets 32 is complicated, making it difficult to perform the simulation in consideration of the electrons. In the above configuration, the influence of the electrons can be reduced to thereby facilitate the design of the ion transporter 30.

Further, the influence of the electrons on the multipole magnets 32 is not constant with time, changing intensity of the ion beam 40 at the beamline end portion 311 with time, that is, making the ion beam 40 at the beamline end portion 311 unstable. According to the configuration of the present invention, this instability can be reduced.

Further, current caused to flow in permanent magnets (ferromagnetic bodies) constituting the multipole magnets 32 by the electrons gives adverse effect not only to the ion beam 40 but also to the ferromagnetic bodies themselves, resulting in adverse effect on the durability and reliability of the ferromagnetic bodies. According to the configuration of the present invention, this adverse effect can be removed, thereby enhancing the reliability and durability of the ion transporter or ion beam irradiator.

With the configuration described above, an ion beam irradiator capable of stably irradiating a sample with high-intensity ion (proton) beam can be obtained. The ion beam irradiator is constituted by the downsizable components including the laser-driven ion/electron generation source, beamline, multipole magnets and electron absorber provided around the beamline, etc., and can thus significantly be downsized as compared to a conventional accelerator using a cyclotron or a high-frequency cavity. Therefore, the ion beam irradiator of the present invention can be easily installed in various facilities such as medical facilities and is favorably used as a medical particle beam irradiator. In this case, when a target and the like used as a laser-driven ion/electron generation source is appropriately set, various types of particles including protons and heavy particles can be irradiated as ions, and the configuration of the present invention described above is clearly effective irrespective of the particle type. Further, when the particle beam is irradiated onto a sample (affected area of a patient), control of the dose of the particle beam or the setting of concrete configuration of the sample may be made in the same manner as in the case of a conventional medical particle beam irradiator.

In the above example, the X-ray shield 34 used for shielding harmful X-ray emitted from the electron absorber 33 does not significantly influence the behavior of the ion beam 40. Thus, in the configuration in which the amount of electrons to be absorbed is small or harmful X-ray is not significantly radiated due to low electron energy, the X-ray shield 34 need not be provided. In this case, the size of the entire radiator can further be reduced. In the case where the X-ray shield 34 is used, the thickness and material thereof are appropriately set based on the energy of the X-ray emitted when the electron beam 41 is absorbed.

The existence of the electron deflection apparatus 35 allows the electron absorber 33 to effectively absorb the electrons. However, in the case where, for example, the amount of emitted electrons is small, the electron deflection apparatus 35 may be omitted for simplification. Also in this case, the size of the entire radiator can further be reduced. It is clear that it is possible to reduce the amount of the electrons that enter the multipole magnets 32 as long as the electron absorber 33 is provided.

The insulators 36 and 37 are used to electrically insulate between the portion of the beamline 31 at which the electron absorber 33 is provided and ion/electron generator (ion/electron generation source) 20 and between the portion of the beamline 31 at which the electron absorber 33 is provided and multipole magnets 32 (magnets for focusing ions). Therefore, another configuration may be adopted as long as it can electrically isolate the portion of the beamline 31 at which the electron absorber 33 is provided to eliminate adverse effect on the ion beam 40. In the case where the insulators 36 and 37 are used, any insulating material can be used as long as it can realize the configuration of FIG. 2 and conforms to the material of the beamline 31.

In the above configuration, the laser-driven ion/electron generator is used as the ion/electron generation source. However, as long as the ion beam having low directivity is emitted and electron beam is also emitted simultaneously with the ion beam, it is clear that the ion transporter having the above configuration is effective even when an ion/electron generation source other than the laser-driven type is employed. That is, the ion transporter of the present invention is also effective in the application other than being used as a part of the ion beam irradiator having the above configuration.

1. An ion transporter that is connected to an ion/electron generation source for generating ion beam and electron beam and uses a magnet for focusing ions to focus the ion beam for output, comprising:
a beamline provided between the ion/electron generation source and output target of the ion beam so as to allow the ion beam to pass therethrough and having the magnet for focusing ions therearound; and
an electron absorber that is provided around the beamline at allocation between the ion/electron generation source and magnet for focusing ions through which the electron beam passes.

2. The ion transporter according to claim 1, wherein an X-ray shield is provided around the electron absorber.

3. The ion transporter according to claim 1, wherein
the portion of the beamline at which the electron absorber is provided and the ion/electron generation source are electrically isolated from each other, and
the portion of the beamline at which the electron absorber is provided and portion at which the magnet for focusing ions is provided are electrically isolated from each other.

4. The ion transporter according to claim 1, wherein
an electron deflection apparatus for spreading out the electron beam is provided around the beamline at a location between the electron absorber and the ion/electron generator.

5. An ion transport method that transports ion beam traveling from an ion/electron generation source for generating ion beam and electron beam and uses a magnet for focusing ions to focus the ion beam for output, comprising:
providing a beamline between the ion/electron generation source and output target of the ion beam so as to allow the ion beam to pass therethrough;
providing the magnet for focusing ions at a portion around the beamline; and
providing an electron absorber around the beamline at a location between the ion/electron generation source and magnet for focusing ions through which the electron beam passes.

6. The ion transport method according to claim 5, wherein
an X-ray shield is provided around the electron absorber.

7. The ion transport method according to claim 5, wherein
the portion of the beamline at which the electron absorber is provided and the ion/electron generation source are electrically isolated from each other, and
the portion of the beamline at which the electron absorber is provided and portion at which the magnet for focusing ions is provided are electrically isolated from each other.

8. The ion transport method according to claim 5, wherein
the trajectory of the electron beam is controlled at a location between the electron absorber and the ion/electron generation source in the direction in which the electron beam is spread out.

9. The ion transport method according to claim 5, wherein
a laser-driven ion/electron generation source in which a target is irradiated by laser light to generate ion beam and electron beam is used as the ion/electron generation source to the output ion beam.

10. An ion beam irradiator that irradiates a sample with ion beam through an ion transporter that is connected to an ion/electron generation source for generating ion beam and electron beam and uses a magnet for focusing ions to focus the ion beam for output, comprising:
a beamline provided between the ion/electron generation source and output target of the ion beam so as to allow the ion beam to pass therethrough and having the magnet for focusing ions therearound; and
an electron absorber that is provided around the beamline at a location between the ion/electron generation source and magnet for focusing ions through which the electron beam passes.

11. The ion beam irradiator according to claim 10, wherein
a laser-driven ion/electron generation source in which a target is irradiated by laser light to generate ion beam and electron beam is used as the ion/electron generation source.

12. A medical particle beam irradiator, wherein
the ion beam is set as particle beam to be radiated,
a laser-driven ion/electron generation source in which a target is irradiated by laser light to generate ion beam and electron beam is used as the ion/electron generation source, and
the ion beam output using an ion transporter that is connected to an ion/electron generation source for generating ion beam and electron beam and uses a magnet for focusing ions to focus the ion beam for output, comprising:
a beamline provided between the ion electron generation source and output target of the ion beam so as to allow the ion beam to pass therethrough and having the magnet for focusing ions therearound; and
an electron absorber that is provided around the beamline at a location between the ion/electron generation source and magnet for focusing ions through which the electron beam passes,
is irradiated.
